(19) United States
(12) Patent Application Publication
(10) Pub. No.: US 2009/0088979 A1
(43) Pub. Date: Apr. 2, 2009

(54) Automated machine navigation system with obstacle detection

(76) Inventor: Roger Dale Koch, Pekin, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/902,979

(22) Filed: Sep. 27, 2007

(51) Int. Cl. G01C 21/04

(52) U.S. Cl. 701/224

(57) ABSTRACT

A system is provided for automatically operating a machine. The system has a position monitor configured to monitor a position of the machine and a plurality of sensors configured to sense objects proximate to the machine. The system also has an obstacle monitor configured to determine the location of previously known and unknown objects proximate to the machine, the determination being based on data received from successive scans performed by the plurality of sensors. Furthermore, the system has a path generator configured to generate a path that is based at least in part on data from the position monitor and the obstacle monitor and a path tracker configured to automatically guide and move the machine along the path generated by the path generator.

### TECHNICAL FIELD

The present disclosure is directed to an automated machine navigation system and, more particularly, to an automated machine navigation system capable of detecting obstacles.

### BACKGROUND

The earthmoving industry has an increasing desire to automate the work cycle of earthmoving equipment. Unlike a human operator, an automated machine remains consistently productive regardless of environmental conditions and prolonged work hours. Such an automated machine is ideal for applications where conditions are dangerous, unsuitable or undesirable for humans. To be fully automated, earthmoving machines need to have an automated navigation system capable of planning travel routes and avoiding obstacles.

Such a navigation system can be found in U.S. Patent Publication No. US2006/0089764 (the publication) by Filippov et al. The publication describes an automated navigation system that allows a vehicle to track obstacles and create a vehicle trajectory that avoids such obstacles. The navigation system includes a first array of sensors that periodically sense a vehicle's location relative to a predetermined point and a second array of sensors that periodically sense the environment around the vehicle. If the second array of sensors detects an environment feature (an obstacle) that might be harmful to the vehicle, the location of the harmful feature is stored in the navigation system's memory and all vehicle trajectories are planned around the sensed harmful feature.

Although the system disclosed in the publication may be able to detect obstacles and create a trajectory around such obstacles, the accuracy of the system may be limited. In particular, the system relies on the latest sensor scan to determine the locations of potential obstacles. This may limit the amount of data available for the navigation system's calculations to one quantum of data per sensor. The accuracy of such calculations is related to the amount of data available. Therefore, because the system relies on data from one scan, the system accuracy may be limited to the number of sensors utilized by the system. Moreover, the number of sensors utilized by the system and ultimately the accuracy of the system may be limited by the amount of vehicular surface area on which sensors may be located.

The disclosed apparatus is directed to overcoming one or more of the problems set forth above.

### SUMMARY

In one aspect, the present disclosure is directed toward a system for automatically operating a machine. The system includes a position monitor configured to monitor a position of the machine and a plurality of sensors configured to sense objects proximate to the machine. The system also includes an obstacle monitor configured to determine the location of previously known and unknown objects proximate to the machine, the determination being based on data received from successive scans performed by the plurality of sensors. Furthermore, the system includes a path generator configured to generate a path that is based at least in part on data from the position monitor and the obstacle monitor and a path tracker configured to automatically guide and move the machine along the path generated by the path generator.

Consistent with a further aspect of the disclosure, a method is provided for automatically moving a machine along a path. The method includes scanning for objects as the machine moves along the path and comparing data received from a scan to data received from previous scans. The method also includes determining the location of the objects based on data received from the current and previous scans. The method further includes determining whether any of the objects interfere with the path of the machine and adjusting the path if it is determined that the object interferes with the path of the machine.

### BRIEF DESCRIPTION OF THE DRAWINGS

FIG. 1 is a pictorial representation of a side view of an exemplary machine;

FIG. 2 is a block diagram of an exemplary control system for the machine of FIG. 1;

FIG. 3A is a diagrammatic representation of an exemplary map of an exemplary worksite;

FIG. 3B is another diagrammatic representation of the exemplary map of FIG. 3A;

FIG. 3C is another diagrammatic representation of the exemplary map of FIG. 3A; and

FIG. 4 is a flow diagram and associated illustration of an exemplary disclosed method for generating a path for a machine.

### DETAILED DESCRIPTION

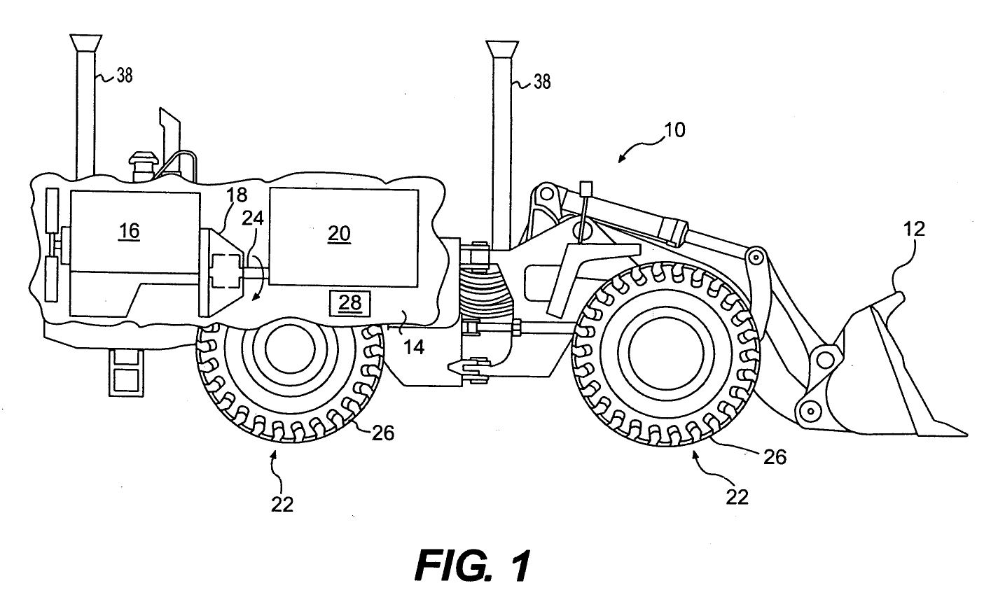

FIG. 1 illustrates an exemplary embodiment of a machine 10. Machine 10 may be a mobile machine that performs some type of operation associated with an industry such as mining, construction, farming, transportation, or any other industry known in the art. For example, machine 10 may be an earth moving machine such as a wheel loader, a dump truck, a backhoe, a motor grader, or any other suitable operation-performing work machine. Machine 10 may include a work implement 12 and a drive system 14. Although the exemplary machine 10 in FIG. 1 is illustrated without a cab for an operator, it is contemplated that machine 10 may include an operator cab in embodiments capable of being manually operated.

Work implement 12 may include any device used to perform a particular task. For example, work implement 12 may include a bucket, a fork arrangement, a blade, a shovel, a ripper, a dump bed, a broom, a snow blower, a propelling device, a cutting device, a grasping device, or any other task-performing device known in the art. Work implement 12 may be connected to machine 10 via a direct pivot, via a linkage system, via one or more hydraulic cylinders, or in any other appropriate manner. Work implement 12 may be configured to pivot, rotate, slide, swing, lift, or move relative to machine 10 in any manner known in the art.

Drive system 14 may include components that interact to propel machine 10. In particular, drive system 14 may include a power source 16, a torque converter 18, and a transmission 20 connected to one or more driven traction devices 22. It is contemplated that additional and/or different components may be included within drive system 14 such as, for example, additional ratio reducing devices located between transmission 20 and driven traction device 22.

Power source 16 may include an internal combustion engine such as, for example, a diesel engine, a gasoline engine, a gaseous fuel-powered engine such as a natural gas engine, or any other engine apparent to one skilled in the art. Power source 16 may alternatively include another source of power such as a furnace, a battery, a fuel cell, a motor, or any other appropriate source of power. Power source 16 may be configured to produce a power output that is directed to torque converter 18.

Torque converter 18 may be a hydraulic device configured to couple power source 16 to transmission 20. Torque converter 18 may allow power source 16 to rotate somewhat independently of transmission 20. The amount of independent rotation between power source 16 and transmission 20 may be varied by modifying operation of torque converter 18. It is contemplated that torque converter 18 may alternatively embody a non-hydraulic device such as, for example, a mechanical diaphragm clutch. It is further contemplated that torque converter 18 may be omitted, if desired, and transmission 20 connected directly to power source 16.

Transmission 20 may be configured to transmit power from power source 16 to driven traction device 22 at a range of output speed ratios. Transmission 20 may embody a hydraulic transmission having one or more pumps (not shown) and hydraulic motors (not shown), a mechanical transmission having a mechanical gear train (not shown), a hydro-mechanical transmission having both hydraulic and mechanical components (not shown), an electric transmission having a generator (not shown) and one or more electric motors (not shown), or any other suitable transmission. An input drive member such as, for example, a countershaft 24, may connect transmission 20 to torque converter 18. In this manner, power generated by power source 16 may be transmitted through transmission 20 to driven traction device 22. It is contemplated that transmission 20 may alternatively transmit power from power source 16 to driven traction device 22 at only a single output speed ratio.

Driven traction device 22 may include wheels 26 located on each side of work machine 10 (only one side shown). Alternatively, driven traction device 22 may include tracks, belts or other traction devices.

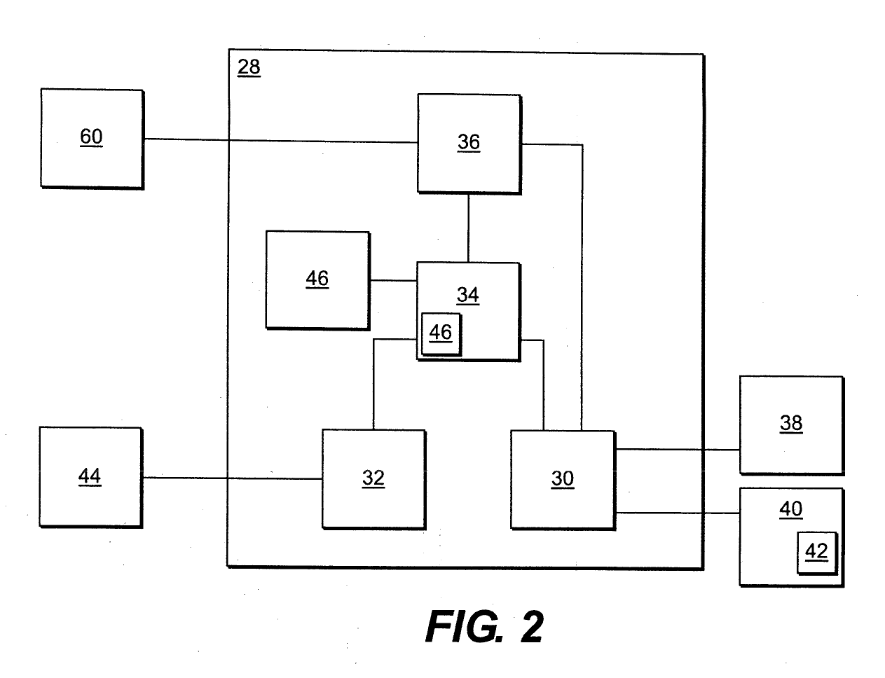

FIG. 2 illustrates a control system 28, which may take many forms including, for example, a computer based system, a microprocessor based system, a microcontroller, or any other suitable control type circuit or system. Control system 28 may be located anywhere in machine 10 and may include various components for running software applications designed to regulate various subsystems of machine 10. For example, control system 28 may include a central processing unit (CPU), a random access memory (RAM), input/output (I/O) elements, etc. Furthermore, control system 28 may include a position monitor 30, an obstacle monitor 32, a path generator 34, and a path tracker 36. These components may communicate with each other to guide machine 10 along a generated path within a worksite.

Position monitor 30 may receive positioning data from one or more global positioning system (GPS) satellites via at least one GPS receiver 38 to determine the location of machine 10 in relation to a global set of coordinates. In addition, position monitor 30 may transmit data relating to the position of machine 10 to path generator 34 and path tracker 36. Position monitor 30 may be a computer based system and include various components for running software applications designed to determine the position of machine 10. For example, position monitor 30 may include a central processing unit (CPU), a random access memory (RAM), input/output (I/O) elements, etc.

In operation, each GPS receiver 38 may communicate with one or more GPS satellites to determine its position with respect to a selected coordinate system. GPS receivers 38 may be attached to one or more locations on machine 10. For example, GPS receivers 38 may be placed at opposing ends of machine 10 to determine the position of each end. By knowing the position of each end of machine 10, position monitor 30 may determine the orientation and location of machine 10. In an alternate embodiment, a single GPS receiver 38 may be mounted on machine 10 to determine the position of machine 10 relative to the worksite.

It is contemplated that position monitor 30 may also receive positioning data from a local positioning unit 40 to supplement GPS receivers 38, if desired. Local positioning unit 40 may enable GPS receivers 38 to more accurately monitor the position of machine 10. In addition, local positioning unit 40 may be a reference station at or near the worksite and may include any system for determining the position of machine 10 in a coordinate system. Furthermore, local positioning unit 40 may be placed away from machine 10 at a surveyed location with a known position. Local positioning unit 40 may be part of a differential GPS (DGPS), and may include a GPS receiver 42. GPS receiver 42 may be used to determine the position of local positioning unit 40. Any discrepancy between the actual, known position of local positioning unit 40 (as established by survey) and its determined position obtained using GPS receiver 42 may be considered to be error on the part of GPS receiver 42. A correction factor may be generated to compensate for any discrepancy and may be used to correct errors in the determined positions of local positioning unit 40 that are obtained using GPS receiver 42. This correction factor may also be applied to determined positions obtained using other GPS receivers in the vicinity. Accordingly, the correction factor may be used to modify the determined position of machine 10 that is obtained using GPS receivers 38. Use of this correction factor may enable position monitor 30 to more accurately determine the position of machine 10.

Obstacle monitor 32 may receive data from an array of sensors 44 situated throughout the exterior surface of machine 10. Sensors 44 may sense the location of worksite features relative to the location of machine 10. Such worksite features may pose a hazard to machine 10 as machine 10 travels through the worksite. Upon receiving the obstacle data from sensors 44, obstacle monitor 32 may transmit the location of potential obstacles to path generator 34. Obstacle monitor 32 may be a computer based system and include various components for running software applications designed to determine the location of various work site obstacles. For example, obstacle monitor 32 may include a central processing unit (CPU), a random access memory (RAM), input/output (I/O) elements, etc. In addition, sensors 44 may be any combination of ultrasonic sensors, radar sensors, optical sensors, or any other type of sensor capable of detecting the location of various obstacles relative to machine 10.

Path generator 34 may create a travel path for machine 10 based on position data from position monitor 30, obstacle data from obstacle monitor 32, and a preexisting worksite map 46. Path generator 34 may be a computer based system including various components for running software applications designed to create a travel path for machine 10. For example, path generator 34 may include a central processing unit (CPU), a random access memory (RAM), input/output (I/O) elements, etc.

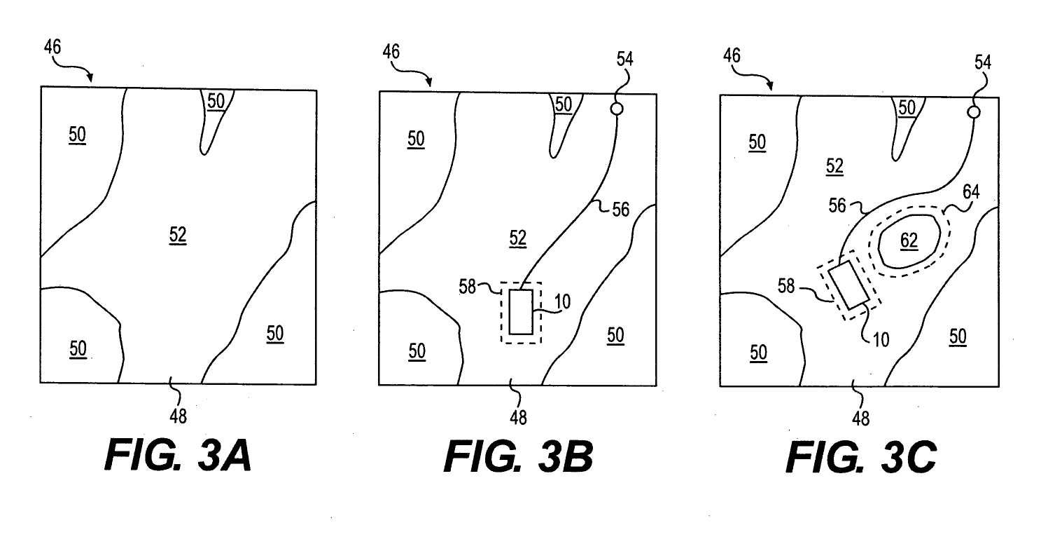

FIG. 3A illustrates a map 46 of an exemplary worksite 48 from which path generator 34 may create a travel path for machine 10. Map 46 may describe the topography of worksite 48 and may be pre-made and stored in or downloaded into the memory of path generator 34. Map 46 may divide the topography of worksite 48 into non-travel areas 50 and travel areas 52. Non-travel areas 50 may be areas though which it may be unsuitable for machine 10 to travel such as, for example, rock outcroppings, boulders, chasms, other machines 10, or any other known worksite feature that may inhibit the travel of machine 10. In contrast, travel areas 52 may be areas through which it may be suitable for machine 10 to travel such as, for example, flat terrain, worn paths, or any other worksite feature that may be suitable for machine 10 to travel through. The boundaries for non-travel areas 50 and travel areas 52 may be predetermined by surveys of worksite 48 or existing obstacle data from sensors 44 received during previous excursions through worksite 48.

As illustrated in FIG. 3B, path generator 34 may add a current position of machine 10 and a destination 54 to map 46 before creating a path 56. Path 56 may extend from machine 10 to destination 54. It is contemplated that the location of destination 54 may be previously determined and stored or downloaded into the memory of path generator 34. Alternatively, path generator 34 may select a location of destination 54 from a plurality of locations based on any number of factors. Path 56 may run through travel areas 52 and may be generated based on any number of factors such as, for example, location of destination 54, distance of travel, travel duration, location of non-travel areas 50, or any other factor that may affect the course of path 56.

A safety zone 58 may surround the representation of machine 10 on map 46, and path 56 may be chosen so that non-travel areas 50 will not penetrate safety zone 58. It is contemplated that safety zone 58 may reflect inherent inaccuracies in the position data received by GPS receivers 38. For example, if the position data is accurate to within one foot of the actual position of machine 10, safety zone 58 may extend beyond machine 10 to a distance equivalent to one foot as represented on map 46. Alternatively, safety zone 58 may be omitted and the representation of machine 10 may be enlarged to an area equivalent to the area that would otherwise be defined by machine 10 and safety zone 58. In such an embodiment, path 56 may be chosen so that non-travel areas 50 will not penetrate the exterior of machine 10.

Referring back to FIG. 2, path tracker 36 may guide machine 10 along the path created by path generator 34 by utilizing position data from position monitor 30. In addition, path tracker 36 may include various components for running software applications designed to guide machine 10 along the path generated by path generator 34. For example, path tracker 36 may include a central processing unit (CPU), a random access memory (RAM), input/output (I/O) elements, etc. Path tracker 36 may utilize any number of algorithms designed to keep machine 10 traveling along the path generated by path generator 34. Furthermore, path tracker 36 may send signals to a steering system 60 based on calculations made by the algorithm. Steering system 60 may adjust the course of machine 10 based on signals transmitted by path tracker 36. Steering system 60 may be any type of steering system such as, for example, a skid-steer type steering system or all-wheel steering. Furthermore, steering system 60 may include any clutches (not shown) and/or brakes (not shown) necessary to adequately adjust the course of machine 10.

FIG. 3C illustrates map 46 as path tracker 36 guides machine 10 along path 56. While machine 10 travels along path 56, sensors 44 may continuously or periodically scan the surrounding environment for new obstacles or changes in the shape or location of previously known obstacles. Upon detecting a newly detected object 62, path generator 34 may add a representation of object 62 to map 46, classify it as a non-travel area 50, and modify path 56 accordingly. Due to inherent inaccuracies in the obstacle data transmitted by sensors 44, path generator 34 may surround object 62 with a safety zone 64 large enough to account for discrepancies in the obstacle data.

As machine 10 continues to travel along path 56, sensors 44 may continue scanning object 62. Path generator 34 may compare data from each successive scan to data previously recorded by path generator 34 to filter out errant data and more accurately determine the location of object 62 and ultimately reduce the size of safety zone 64. For example, each scan of object 62 may indicate a location of object 62 that may be different from other scans. If the distance between these locations is less than or equivalent to the error rate of sensors 44, the object may be stationary, and path generator 34 may apply an averaging filter to the obstacle data to more accurately determine the location of object 62. If the distance between the sensed locations is greater than the error rate of sensors 44, the object may be moving. Path generator 34 may determine a location trend in the obstacle data and apply an averaging filter to the data to predict future locations of the object. It should be understood that sensors 44 may also continuously scan previously known obstacles in worksite 48 and adjust map 46 as the locations and/or shapes of the previously known obstacles change. Furthermore, if a previously known obstacle is no longer located within worksite 48, path generator 34 may remove the object from map 46.

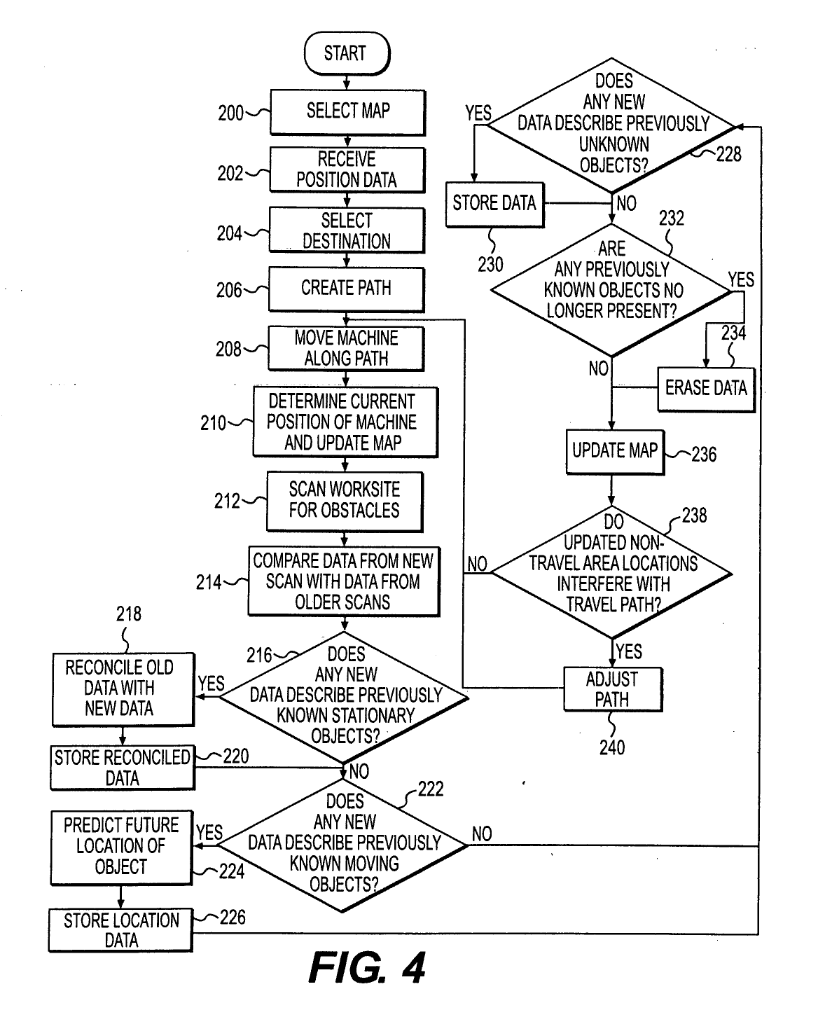

FIG. 4, which is discussed in the following section, illustrates the operation of machine 10 utilizing embodiments of the disclosed system. FIG. 4 illustrates an exemplary method used to generate and adjust a path for traversing a worksite as machine 10 travels along generated path 56.

### INDUSTRIAL APPLICABILITY

The disclosed system may autonomously navigate a machine through a worksite to a predetermined destination while avoiding obstacles. In particular, the disclosed system may accurately determine the location of potential worksite obstacles by comparing successive scans of the worksite environment and applying an averaging filter to the data. Such successive scans and data filtering may produce location data accurate enough to safely guide the machine through hazardous environments and allow the machine accomplish desired tasks. The operations of path generator 34 and path tracker 36 will now be explained.

FIG. 4 illustrates a flow diagram depicting an exemplary method of path generation and path modification. The method may begin by selecting a map 46 of worksite 48 (step 200). Map 46 may be one of a plurality of maps stored within the memory of path generator 34, wherein each map may describe a different worksite. Path generator 34 may select map 46 based on the characteristics of the worksite through which machine 10 may travel. Alternatively, it is contemplated that map 46 may be downloaded into the memory of path generator 34 by an operator or another control system. In such an embodiment, map 46 may be the only map stored within the memory of path generator 34, and path generator 34 may access map 46 rather than select map 46 from a plurality of maps.

In one exemplary embodiment, map 46 may include non-travel areas 50 having features that may not be conducive for traveling. Map 46 may also include travel areas 52 that may be conducive to travel. Boundaries for both non-travel areas 50 and travel areas 52 may initially be created from previously recorded data such as, for example, a survey of worksite 48. Alternatively, map 46 may initially only include travel areas 52. In such an embodiment, non-travel areas 50 may be added later as machine 10 travels through worksite 48 and obstacle monitor 32 scans worksite 48.

After path generator 34 selects or accesses map 46, path generator 34 may receive data from position monitor 30 indicative of a current position of machine 10 relative to worksite 48 (step 202). Path generator 34 may use the position data to create a representation of machine 10 in map 46. After receiving position data from position monitor 30, path generator 34 may select a destination 54 (step 204). Destination 54 may be selected based on any number of factors such as, for example, position of machine 10, whether work implement has a payload, and geometry of worksite 48. Alternatively, it is contemplated that destination 54 may be predetermined by an operator, if desired. After destination 54 is selected, path generator may create path 56 (step 206). Path 56 may be created based on any number of variables such as, for example, distance, time of travel, and proximity to non-travel areas 50.

After path generator 34 creates path 56, path tracker 36 may guide machine 10 along path 56 (step 208). Path tracker 36 may be in communication with drive system 14 and steering system 60 and may reference various algorithms to control the speed and direction of machine 10 as machine 10 travels along path 56. While path tracker 36 guides machine 10 along path 56, position monitor 30 may periodically or continuously determine the current position of machine 10 via GPS receivers 38 (step 210). Path generator 34 may use the data from position monitor 30 to update map 46, and path tracker 36 may reference the updated map 46 to make course corrections should machine 10 stray from path 56. Also while machine 10 travels along path 56, sensors 44 may periodically or continuously scan worksite 48 to detect the boundaries of non-travel areas 50 (step 212).

New obstacle data received from sensors 44 may be compared to existing objects data to more accurately determine the location of previously known stationary objects, determine a trend in the location of moving objects, or locate previously unknown stationary obstacles (step 214). In an exemplary embodiment, obstacle monitor 32 may determine whether any portion of the new obstacle data describes previously known stationary objects (step 216). It is contemplated that any number of methods and/or algorithms may be used to identify the obstacle data describing previously known stationary obstacles. For example, if the new obstacle data indicates a location of an object less than a threshold distance from the location of a previously known object, it may be determined that the data describes a previously known stationary obstacle (step 216: Yes). The threshold distance may be equivalent to the error rate of sensors 44 or any other value that may be used to determine whether a stationary object is previously known. After it has been determined that the new data describes a previously known object, the most recent data may be reconciled with previously stored data (step 220). Reconciling the data may be achieved by any method such as, for example, applying an averaging filter to the data. Furthermore, by reconciling the new and old data, the location, size, and/or shape of the previously known stationary obstacle may be more accurately determined. Once reconciled, the obstacle data may be stored for future use (step 220).

If it is determined that no portion the new obstacle data describes a previously known stationary object (step 216: No) or the reconciled obstacle data describing previously known stationary objects has been stored, obstacle monitor 32 may determine whether any portion of the new obstacle data describes previously known moving objects (step 222). It is contemplated that any number of methods and/or algorithms may be used to identify any obstacle data describing previously known objects that are moving. In one exemplary method, an averaging filter may be applied to obstacle data received from the latest and previous sensor scans to detect any trends in the location of an object. If a trend is discovered, it may be determined that the object is moving (step 222: Yes). Upon determining that the object is moving, the trend may be used to predict a future location of the object (step 224). After the future location of the object is predicted, the predicted location and all other location data may be stored for future use (step 226).

If it is determined that the new obstacle data does not describe any previously known moving objects (step 222: No) or the location data has been stored, obstacle monitor 32 may determine whether any portion of the new obstacle data describes any previously unknown obstacles (step 228). It is contemplated that any number of methods and/or algorithms may be used to identify the obstacle data describing previously unknown obstacles. For example, it may be determined that the new data describes a previously unknown object (step 228: Yes) if the obstacle data received from the latest sensor scan indicates an object having a size and shape different from any previously known moving or stationary object, the location of the new object is greater than a distance equivalent to the error rate of sensors 44, and/or obstacle monitor 32 cannot find a trend in the location of the object. If it is determined that the object is previously unknown, data describing the previously unknown object may be stored for future use (step 230).

If it is determined that data from the most recent sensor scan does not describe any previously unknown obstacles (step 228: No) or the data describing previously unknown objects has been stored, obstacle monitor 32 may determine whether any previously known objects are no longer present in the worksite (step 232). It is contemplated that any number of methods and/or algorithms may be used to determine if any previously known objects are no longer present. For example, it may be determined that a previously known object no longer exists (step 232: Yes) if none of the obstacle data received from the latest sensor scan indicates any objects having a size and shape similar to the previously known moving or stationary object, the location of the previously known object is greater than a distance equivalent to the error rate of sensors 44 from any object described by data from the latest sensor scan, and/or no trend in the location of the object can be found when analyzing data from the latest and previously performed sensor scans. If it is determined that the previously known object no longer exists (step 232: Yes), data describing the previously known object may be released (step 234).

If it is determined that all previously known obstacles still exist (step 232: No) or the data describing the previously known obstacle that no longer exists has been erased, path generator 34 may update map 46 to reflect the new data (step 236). After updating map 46, path generator 34 may determine whether the newly determined object locations may interfere with the travel of machine 10 (step 238). In particular, path generator 34 may determine whether any of the objects intersect or come within a predetermined distance of travel path 56. If path generator 34 determines that the updated locations of the previously known and unknown objects may interfere with the travel path of machine 10 (step 238: Yes), path generator 34 may adjust travel path 56 to avoid such obstacles (step 240). After travel path 56 has been adjusted, step 208 may be repeated (i.e. path tracker 36 may guide machine 10 along path 56). If path generator 34 determines that the updated locations of the previously known and unknown objects may not interfere with the travel path of machine 10 (step 238: No), step 208 may be repeated (i.e. path tracker 36 may guide machine 10 along path 56).

By reconciling data from multiple scans of the worksite, the location of potential obstacles may be more accurately determined. In particular, utilizing data from previous scans to determine the location of potential obstacles may increase the amount of data available for calculations performed by the navigation system. Therefore, each successive scan of the environment surrounding the machine may increase the accuracy of the system because the increased available data may increase the accuracy of the system.

It will be apparent to those skilled in the art that various modifications and variations can be made in the disclosed system without departing from the scope of the disclosure. Other embodiments will be apparent to those skilled in the art from consideration of the specification disclosed herein. It is intended that the specification and examples be considered as exemplary only, with a true scope being indicated by the following claims and their equivalents.

What is claimed is:

1. A system for automatically operating a machine comprising:
a position monitor configured to monitor a position of the machine;
a plurality of sensors configured to sense objects proximate to the machine;
an obstacle monitor configured to determine the location of previously known and unknown objects proximate to the machine, the determination being based on data received from successive scans performed by the plurality of sensors;
a path generator configured to generate a path that is based at least in part on data from the position monitor and the obstacle monitor; and
a path tracker configured to automatically guide and move the machine along the path generated by the path generator.

2. The system of claim 1, wherein the obstacle monitor is configured to determine whether an obstacle is stationary or moving.

3. The system of claim 2, wherein the obstacle monitor is configured to determine a trend in data received from successive sensor scans describing the location of a moving object.

4. The system of claim 3, wherein the obstacle monitor is configured to predict future locations of the object based on the determined trend.

5. The system of claim 4, wherein the obstacle monitor is configured to determine the trend by applying an averaging filter to data received from the successive scans.

6. The system of claim 2, wherein the obstacle monitor is configured to determine the location of the objects by reconciling data received from successive scans.

7. The system of claim 6, wherein the obstacle monitor is configured to reconcile the data by applying an averaging filter to the data.

8. The system of claim 1, wherein the obstacle monitor is configured to determine if a previously known object proximate to the machine no longer exists.

9. The system of claim 8, wherein the obstacle monitor is configured to erase data relating to the previously known object if it no longer exists.

10. A method for automatically moving a machine along a path comprising:
scanning for objects as the machine moves along the path;
comparing data received from a scan to data received from previous scans;
determining the location of the objects based on data received from the current and previous scans;
determining whether any of the objects interfere with the path of the machine;
adjusting the path if it is determined that the object interferes with the path of the machine.

11. The method of claim 10, further including determining whether the objects are moving or stationary.

12. The method of claim 11, further including determining a trend in the data describing the location of an object.

13. The method of claim 12, further including predicting future locations of the object based on the trend.

14. The method of claim 13, wherein the trend is determined by applying an averaging filter to the data.

15. The method of claim 11, further including determining the location of an object by reconciling data received from successive scans.

16. The method of claim 15, wherein reconciling the data includes applying an averaging filter to the data received from the successive scans.

17. A machine, comprising:
at least one traction device configured to propel the machine;
a drive system configured to propel drive the at least one traction device; and
an navigation system, including:
a position monitor configured to monitor a position of the machine;
a plurality of sensors configured to sense objects proximate to the machine;
an obstacle monitor configured to determine the location of previously known and unknown objects proximate to the machine, the determination being based on data received from successive scans performed by the plurality of sensors;
a path generator configured to generate a path that is based at least in part on data from the position monitor and the obstacle monitor; and
a path tracker configured to automatically guide and move the machine along the path generated by the path generator.

18. The machine of claim 17, wherein the obstacle monitor is configured to determine whether an obstacle is stationary or moving.

19. The machine of claim 18, wherein the obstacle monitor is configured to determine a trend in data received from successive sensor scans describing the location of a moving object and predict future locations of the object based on the determined trend.

20. The machine of claim 18, wherein the obstacle monitor is configured to determine the location of the objects by reconciling data received from successive scans.
